(19) United States
(12) Patent Application Publication
(10) Pub. No.: US 2026/0073417 A1
(43) Pub. Date: Mar. 12, 2026

(54) INTEGRATED HOME ENERGY ASSESSMENT PLATFORM

(71) Applicant: Aveyo Soar, LLC, American Fork, UT (US)

(72) Inventors: Cory Michael Decker, London (GB); Brian Joseph Decker, Temecula, CA (US)

(21) Appl. No.: 18/882,432

(22) Filed: Sep. 11, 2024

(51) Int. Cl. G06Q 30/0204; G06Q 50/06

(52) U.S. Cl. CPC G06Q 30/0205; G06Q 50/06

(57) ABSTRACT

An integrated home energy assessment apparatus, method, and computer program product are disclosed. The apparatus includes one or more processors and non-transitory computer readable storage media storing code. The code is executable by the processors to perform operations that include querying third-party databases for information pertaining to a home and receiving the information from the third-party databases. The operations include analyzing, via machine learning, the information to identify energy-related features of the home. Each of the features corresponds to a scoring category. The operations include determining a lead score corresponding to each feature and aggregating the lead scores within the scoring category to generate a category score. The operations include determining an overall score for the home based on the category score for each of the scoring categories.

### FIELD

This invention relates to a platform for assessing sales leads and more particularly relates to an integrated home energy assessment platform which utilizes existing third-party data in conjunction with generative artificial intelligence to assess leads for home energy product sales.

### BACKGROUND

In recent years, the push towards renewable energy and energy efficiency has gained substantial momentum. Homeowners are increasingly seeking ways to reduce their carbon footprint and energy costs, leading to a surge in demand for residential energy efficiency upgrades and solar installations. However, the process of conducting comprehensive home energy assessments and identifying high-potential leads for these upgrades remains a significant challenge. Traditional methods often rely on manual data collection and analysis, which can be time-consuming, inconsistent, and prone to inaccuracies.

### SUMMARY

An apparatus for assessing a sales lead for a home energy product is disclosed. A method and program product also perform the functions of the apparatus. The apparatus includes one or more processors and non-transitory computer readable storage media storing code. The code is executable by the processors to perform operations that include querying multiple third-party databases for information pertaining to a home and receive the information from the third-party databases. The operations include analyzing, via machine learning, the information to identify multiple energy-related features of the home. Each of the energy-related features corresponds to a scoring category. The operations include determining a lead score corresponding to each of the energy-related features within the scoring category and aggregating the lead scores within the scoring category to generate a category score. The operations include determining an overall score for the home based on the category score for each of the scoring categories.

The method for assessing a sales lead for a home energy product includes querying, by a processor, multiple third-party databases for information pertaining to a home and receiving, by the processor, the information. The method further includes analyzing, via machine learning, the information to identify multiple energy-related features of the home. Each of the energy-related features corresponds to at least one of multiple scoring categories. The method includes determining, by the processor, a lead score corresponding to each of the energy-related features and aggregating, by the processor, the lead scores within each scoring category to generate a category score. The method further includes determining, by the processor, an overall score for the home based on the category score for each of the scoring categories.

The program product for assessing a sales lead for a home energy product includes a computer readable storage medium and program code. The program code is configured to be executable by a processor to perform operations including querying multiple third-party databases for information pertaining to a home and receiving, from the third-party databases, the information. The operations further include analyzing, via machine learning, the information to identify multiple energy-related features of the home. Each of the energy-related features corresponds to at least one scoring category. The operations include determining a lead score corresponding to each of the energy-related features within each scoring category and aggregating the lead scores within each of the scoring categories to generate a category score. The operations further include determining an overall score for the home based on the category score for each of the scoring categories.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a system for assessing a sales lead for a home energy product, according to various embodiments;

FIG. 2 is a schematic block diagram illustrating an apparatus for assessing a sales lead for a home energy product, according to various embodiments;

FIG. 3 is a schematic block diagram illustrating another apparatus for assessing a sales lead for a home energy product, according to various embodiments;

FIG. 4 is a flow diagram illustrating a method for assessing a sales lead for a home energy product in accordance with some embodiments of the disclosure;

FIG. 5 is a flow diagram illustrating another method for assessing a sales lead for a home energy product in accordance with some embodiments of the disclosure; and

FIG. 6 is a schematic block/flowchart diagram illustrating a system using machine learning to assess a sales lead for a home energy product, according to various embodiments.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the "C" programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

In the present disclosure, where a document, act or item of knowledge is referred to or discussed, this reference or discussion is not an admission that the document, act or item of knowledge or any combination thereof was at the priority date, publicly available, known to the public, part of common general knowledge or otherwise constitutes prior art under the applicable statutory provisions; or is known to be relevant to an attempt to solve any problem with which the present disclosure is concerned.

While certain aspects of conventional technologies have been discussed to facilitate the present disclosure, no technical aspects are disclaimed and it is contemplated that the claims may encompass one or more of the conventional technical aspects discussed herein.

As discussed above, residential energy efficiency and solar markets are experiencing significant growth as homeowners seek to reduce their carbon footprint and energy costs. However, the process of conducting comprehensive home energy assessments and identifying high-potential leads for energy efficiency upgrades and solar installations remains complex and challenging.

In response to these challenges, there is a pressing need for an advanced, cohesive, automated system that streamlines assessment and lead qualification processes. What is also needed is a system that integrates information from diverse third-party sources to provide insights into a home's historical energy performance and identifies areas for improvement and potential energy savings. Beneficially, such a system would increase the accuracy and efficiency of energy assessment and lead qualification processes, be adaptable to various property types and regions, and provide dynamic updating capabilities.

The present disclosure addresses these and other issues.

An apparatus for assessing a sales lead for a home energy product is disclosed. A method and program product also perform the functions of the apparatus. The apparatus includes one or more processors and non-transitory computer readable storage media storing code. The code is executable by the processors to perform operations that include querying multiple third-party databases for information pertaining to a home and receive the information from the third-party databases. The operations include analyzing, via machine learning, the information to identify multiple energy-related features of the home. Each of the energy-related features corresponds to a scoring category. The operations include determining a lead score corresponding to each of the energy-related features within the scoring category and aggregating the lead scores within the scoring category to generate a category score. The operations include determining an overall score for the home based on the category score for each of the scoring categories.

In some embodiments, the information includes aerial imagery data, property data, utility rate data, and/or demographic data. In certain embodiments, receiving the information includes including at least a portion of the information from a homeowner via a user interface. In some embodiments, the energy-related features include property characteristics, energy consumption patterns, and/or solar energy potential. In some embodiments, the scoring categories include a solar system installation feasibility for the home, an energy savings potential for a homeowner of the home, a financial readiness of the homeowner, and/or an engagement probability that the homeowner will engage with a solar system salesperson.

In some embodiments, determining the overall score includes calculating a weighted average of the plurality of category scores. Calculating the weighted average may include assigning, in a training phase of the machine learning, a weighting to each of the plurality of category scores based on its relative importance. In some embodiments, the weighting is updated during an operational phase of the machine learning. In certain embodiments, the operations further include dynamically updating the lead score, the category score, and/or the overall score in response to the updated weighting. The operations may further include automatically categorizing the home into one of multiple tiers based on the overall score. Each of the tiers may indicate a sales priority for the home.

The method for assessing a sales lead for a home energy product includes querying, by a processor, multiple third-party databases for information pertaining to a home and receiving, by the processor, the information. The method further includes analyzing, via machine learning, the information to identify multiple energy-related features of the home. Each of the energy-related features corresponds to at least one of multiple scoring categories. The method includes determining, by the processor, a lead score corresponding to each of the energy-related features and aggregating, by the processor, the lead scores within each scoring category to generate a category score. The method further includes determining, by the processor, an overall score for the home based on the category score for each of the scoring categories.

In some embodiments, receiving the information further includes receiving, from a homeowner via a user interface, at least a portion of the information. In some embodiments, determining the overall score includes calculating a weighted average of the plurality of category scores. Calculating the weighted average may include assigning, in a training phase of the machine learning, a weighting to each of the category scores based on its relative importance. In some embodiments, the method includes updating, during an operational phase of the machine learning, the weighting. The processor may dynamically update the lead score, the category score, and/or the overall score in response to the updated weighting.

The program product for assessing a sales lead for a home energy product includes a computer readable storage medium and program code. The program code is configured to be executable by a processor to perform operations including querying multiple third-party databases for information pertaining to a home and receiving, from the third-party databases, the information. The operations further include analyzing, via machine learning, the information to identify multiple energy-related features of the home. Each of the energy-related features corresponds to at least one scoring category. The operations include determining a lead score corresponding to each of the energy-related features within each scoring category and aggregating the lead scores within each of the scoring categories to generate a category score. The operations further include determining an overall score for the home based on the category score for each of the scoring categories.

In some embodiments, determining the overall score includes calculating a weighted average of the plurality of category scores. In some embodiments, calculating the weighted average includes assigning, in a training phase of the machine learning, a weighting to each of the category scores based on its relative importance. In some embodiments, the operations further include updating, during an operational phase of the machine learning, the weighting.

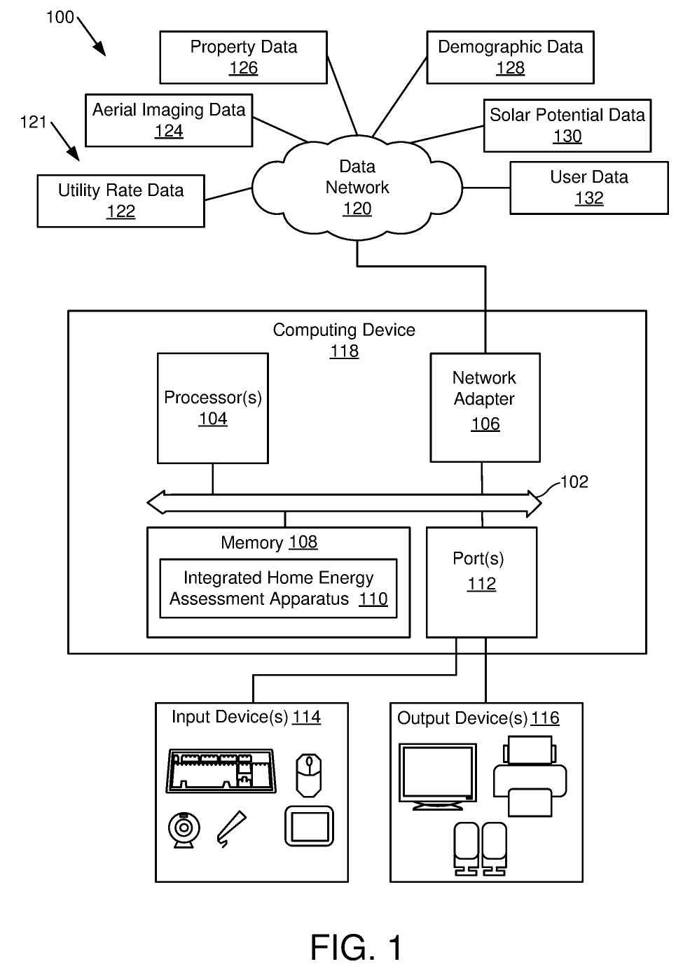

FIG. 1 is a schematic block diagram illustrating a system 100 for assessing a sales lead for a home energy product, according the various embodiments. The system 100 includes a computing device 118 that may be implemented in connection with an integrated home energy assessment apparatus 110 in accordance with various embodiments. The integrated home energy assessment apparatus 110 may be designed to optimize identification of sales leads for energy-related products through a combination of advanced data analysis and machine learning. The computing device 118 includes one or more processors 104 connected to non-transitory computer-readable storage media that store executable code. This code enables the computing device 118 to perform various tasks necessary for home energy assessments, including processing input data, interaction with external data sources, and communication with users through input and output devices 114, 116.

In some embodiments, the computing device 118 includes a network adapter 106 configured to facilitate communication with external data sources over a data network 120, thereby allowing the computing device 118 to retrieve critical data for energy assessment. In some embodiments, the computing device 118 communicates with one or more third-party databases 121 to access utility rate data 122, aerial imaging data 124, property data 126, demographic data 128, and/or solar potential data 130. In some embodiments, the computer system 118 incorporates a user interface to receive user data 132 from a homeowner or other authorized user over the data network 120.

The operating environment 100 may include one or more computing devices 118 and one or more data networks 120 configured to communicate with various third-party databases 121. In some embodiments, the computing device 118 is a cloud server and at least one of the data networks 120 is a cloud computing network. Although a specific number of computing devices 118, data networks 120, and third-party databases 121 are depicted in FIG. 1, one of skill in the art will recognize that any number of data networks 120 and third-party databases 121 may be included in the operating environment 100 and accessed by any number of computing devices 118.

In some embodiments, the computing device 118 may be embodied as one or more of a desktop computer, a server device, a laptop computer, a tablet computer, a smart phone, an Internet of Things device, or another computing device that includes a processor 104 (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device, a volatile or non-volatile memory 108 or storage medium, and/or an output device 116 such as a display, a connection to a display, and/or the like.

In general, the computing device 118 includes an integrated home energy assessment apparatus 110 configured to leverage artificial intelligence (“AI”) and comprehensive data analysis to improve precision of home energy assessment processes and to optimize the identification and prioritization of sales leads. The integrated home energy assessment apparatus 110 may provide deep insights into a home’s energy performance and pinpoint areas for improvement and potential energy savings. In some embodiments, at least a portion of the integrated home energy assessment apparatus 110 is included in the computing device 118 and/or distributed across various computing devices 118 and/or other suitable devices. In some examples, a portion of the integrated home energy assessment apparatus 110 may include an application programming interface (“API”) configured to access the integrated home energy assessment apparatus 110 on the computing device 118.

In certain embodiments, integrated home energy assessment apparatus 110 includes a hardware device such as a secure hardware dongle or other hardware appliance device that attaches to devices such as a laptop computer, a server, a tablet computer, a smart phone, or the like, either by a wired connection (e.g., a universal serial bus (“USB”) connection) or a wireless connection (e.g., Bluetooth®, Wi-Fi, near-field communication (“NFC”), or the like). In various embodiments, a hardware appliance device of the integrated home energy assessment apparatus 110 includes a power interface, a wired and/or wireless network adapter 106, one or more ports 112, and/or a semiconductor integrated circuit device as described below, configured to perform the functions described herein with regard to the integrated home energy assessment apparatus 110.

The integrated home energy assessment apparatus 110, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor 104, a processor core, or the like. In some embodiments, the integrated home energy assessment apparatus 110 is mounted on a printed circuit board with one or more electrical lines or connections 102 (e.g., to volatile memory 108, a non-volatile storage medium 108, a network adapter 106 or interface, a peripheral device such as input devices 114 and/or output devices 116, a graphical/display interface, or the like).

Where the integrated home energy assessment apparatus 110 is implemented using a programmable hardware device and/or hardware circuits, in certain embodiments, the integrated home energy assessment apparatus 110 includes and/or is communicatively coupled to one or more volatile memory media 108, which may include but is not limited to random access memory (“RAM”), dynamic RAM (“DRAM”), cache, or the like. In some embodiments, the semiconductor integrated circuit device or other hardware appliance of the integrated home energy assessment apparatus 110 includes and/or is communicatively coupled to one or more non-volatile memory media 108, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 120, in some embodiments, includes a digital communication network that transmits digital communications. The data network 120 may include a wireless network, such as a wireless cellular network, a local wireless network, such as a Wi-Fi network, a Bluetooth® network, a near-field communication (“NFC”) network, an ad hoc network, and/or the like. The data network 120 may include a wide area network (“WAN”), a storage area network (“SAN”), a local area network (“LAN”) (e.g., a home network), an optical fiber network, the internet, or other digital communication network. The data network 120 may include two or more networks. The data network 120 may include one or more servers, routers, switches, and/or other networking equipment. The data network 120 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In some embodiments, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

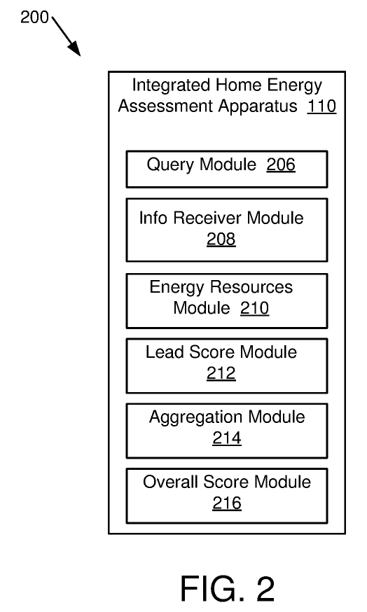

FIG. 2 is a schematic block diagram illustrating an apparatus 200 for assessing a sales lead for a home energy product, according to various embodiments. The apparatus 200, in some embodiments, is for assessing a sales lead for a home energy product and includes the integrated home energy assessment apparatus 110. The integrated home energy assessment apparatus 110 may include code executable by the processor(s) 104 to assess a home’s energy efficiency and potential for solar and other energy efficient upgrades without relying on manual data collection and analysis. The integrated home energy assessment apparatus 110, in some embodiments, is configured to efficiently access, integrate, and analyze property and solar potential data from various third-party databases 121 to identify and prioritize high-potential leads in a standardized, data-driven manner. In this manner, the integrated home energy assessment apparatus 110 may produce reliable, repeatable results.

In some embodiments, the integrated home energy assessment apparatus 110 includes a query module 206, an information receiver module 208, an energy resources module 210, a lead score module 212, an aggregation module 214, and/or an overall score module 216, which are described below. The query module 206 is configured to query multiple third-party databases 121 for information pertaining to a home. In some embodiments, the query module 206 is configured to efficiently gather and process information such as utility rate data 122, aerial imaging data 124, property data 126, demographic data 128, solar potential data 130, and/or the like. In certain embodiments, the query module 206 is further configured to query the homeowner or other authorized user for information.

The apparatus 200 includes a query module 206, in some embodiments, configured to query one or more utility databases that include accurate and up-to-date utility rate information associated with the home, including initial and ongoing costs and current energy consumption patterns. In some embodiments, the query module 206 queries one or more utility databases, for example via an application programming interface (“API”), that supply utility rate information including time-of-use rates. In certain embodiments, the query module 206 queries OpenEI Utility Rates Database or other open-source repositories that provide utility rates across various regions.

In some embodiments, the query module 206 queries one or more aerial imaging databases such as Google® Maps, Google® Earth, Nearmap®, and/or the like, to obtain aerial imaging data 124 demonstrating desired property characteristics such as size, age, and/or construction type of the home. In some embodiments, the query module 206 queries one or more property databases or data services such as Zillow® or CoreLogic® to obtain property data 126 to confirm and/or supplement the utility rate data 122 and/or the aerial imaging data 124. The property data 126 may include detailed property data such as square footage, building type, year of construction, property valuation, building materials, historical transaction data, and/or the like.

In some embodiments, the query module 206 queries one or more third-party databases such as the census bureau or ESRI® demographics to obtain demographic data 128 such as income levels, age distribution, household size, consumer spending patterns, and/or lifestyle segmentation, for example.

In some embodiments, the query module 206 queries one or more third-party databases to obtain solar potential data 130, including weather and climate data. For example, the query module 206 may query the National Renewable Energy Laboratory (“NREL”) to obtain data on solar irradiance and potential, and/or HelioScope® to obtain shading analysis and energy production estimates. In some embodiments, the query module 206 queries the National Oceanic and Atmospheric Administration (“NOAA”) to obtain historical weather data and climate models that can impact energy consumption and solar energy potential and/or Dark Sky API to obtain hyperlocal weather data, including historical sunshine hours.

The apparatus 200 includes an information receiver module 208 configured to receive the information from the various third-party databases. In some embodiments, the information receiver module 208 is further configured to receive user information input by the homeowner or user. In some embodiments, the information receiver module 208 is configured to store the information in volatile or non-volatile memory 108.

The apparatus 200 includes an energy resources module 210 configured to analyze, via machine learning, the information to identify multiple energy-related features of the home. In some embodiments, the identified energy-related features are used for assessing the home’s energy efficiency, potential for energy savings, and suitability for energy-related products such as solar panels or energy-efficient appliances. The energy resources module 210, in some embodiments, is configured to integrate and/or preprocess the data collected from various third-party databases, such as utility rate data 122, aerial imaging data 124, property data 126, demographic data 128, solar potential data 130, and/or the like. In some embodiments, the energy resources module 210 is further configured to integrate and/or preprocess user data 132 received from the homeowner or other user. Pre-processing the data, in some embodiments, includes cleaning the data to remove inconsistencies, normalizing data formats, combining data from multiple third-party databases 121 to create a comprehensive profile of the home, and/or performing other suitable pre-processing steps.

In some embodiments, the energy resources module 210 is configured to analyze property characteristics to identify energy-related features relevant to the home’s energy profile. Each of the energy-related features may correspond to at least one scoring category. The scoring categories may include, for example, property characteristics, energy consumption patterns, solar energy potential, energy savings potential, financial readiness and incentives, and/or any other desired scoring category that would help in identifying a sales lead.

In some examples, the energy resources module 210 analyzes aerial imaging data 124 to identify and assess the home’s property characteristics. In some embodiments, the property characteristics include roof size, shape, orientation, and/or other features relevant to determining solar panel installation potential. A large, south-facing roof with minimal shading, for example, is ideal for solar energy production. In some embodiments, the energy resources module 210 analyzes property data 126 in conjunction with aerial imaging data 124 to identify other relevant property characteristics, such as building materials and insulation and window placement and type. These energy-related features may significantly impact energy consumption and heating and cooling loads.

In some embodiments, the energy resources module 210 integrates utility rate data 122 to analyze historical energy consumption patterns such as peak usage times, seasonal variations, and/or overall energy demand. In some embodiments, the energy resources module 210 is configured to cross-reference demographic data 128 and property data 126 to infer the types of appliances and HVAC systems in use. In this manner, the energy resources module 210 may identify energy-intensive appliances and assess the efficiency of heating, ventilation, and/or air conditioning systems in the home.

In some embodiments, the energy resources module 210 utilizes solar potential data 130 to assess the average solar irradiance the home receives throughout the year. The energy resources module 210 may include factors such as geographic location, shading from nearby structure or trees, and/or roof angle in its analysis. In some embodiments, the energy resources module 210 performs a detailed shading analysis using aerial imagery and 3D modeling to identify potential obstructions that could reduce the effectiveness of solar panels. The energy resources module 210 may also calculate available roof space for solar panel installation, considering obstructions like chimneys or skylights.

In some embodiments, the energy resources module 210 assesses the home’s potential for energy efficiency upgrades, such as insulation improvements, window replacements, and/or installation of energy-efficient appliances. In some embodiments, the energy resources module 210 evaluates the cost-benefit ratio of these upgrades to identify opportunities for energy savings. In some embodiments, the energy resources module 210 analyzes demographic data 128 to infer household behaviors that affect energy consumption, such as occupancy patterns and/or the likelihood of adopting energy saving practices.

In some embodiments, the energy resources module 210 cross-references utility rate data 122 and government records to identify available incentives, rebates, and/or financing options for energy-related improvements. In addition, in some embodiments, the energy resources module 210 may utilize demographic data 128 and property data 126 to assess the financial readiness of the homeowner, considering factors such as income level, credit score, existing mortgage obligations, and/or the like. These factors affect the likelihood that the homeowner will pursue energy upgrades or solar installations.

In some embodiments, the apparatus 200 includes a lead score module 212 configured to determine a lead score corresponding to each of the plurality of energy-related features within one of the plurality of scoring categories. Upon identification of each of the energy-related features and its corresponding scoring category by the energy resources module 210, in some embodiments, the lead score module 212 assigns a lead score to each of the energy-related features based on its relevance to its associated category. In some embodiments, the lead score assigned to each energy-related feature is predetermined. In certain embodiments, the lead score includes a numerical score, an alphanumerical score, and/or any other suitable designation or score or combination thereof. In one embodiment, the lead score is a whole number in a range between one and one hundred (1-100).

The apparatus 200 includes an aggregation module 214 configured to aggregate the lead scores within each of the scoring categories to generate a category score for each scoring category. In some embodiments, the aggregation module 214 is configured to sum the lead scores within a scoring category. In other embodiments, the aggregation module 214 is configured to apply a predetermined weighting to each lead score prior to aggregating the lead scores. In certain embodiments, the aggregation module 214 is configured to average the lead scores or calculate a weighted average of the lead scores to generate the category score.

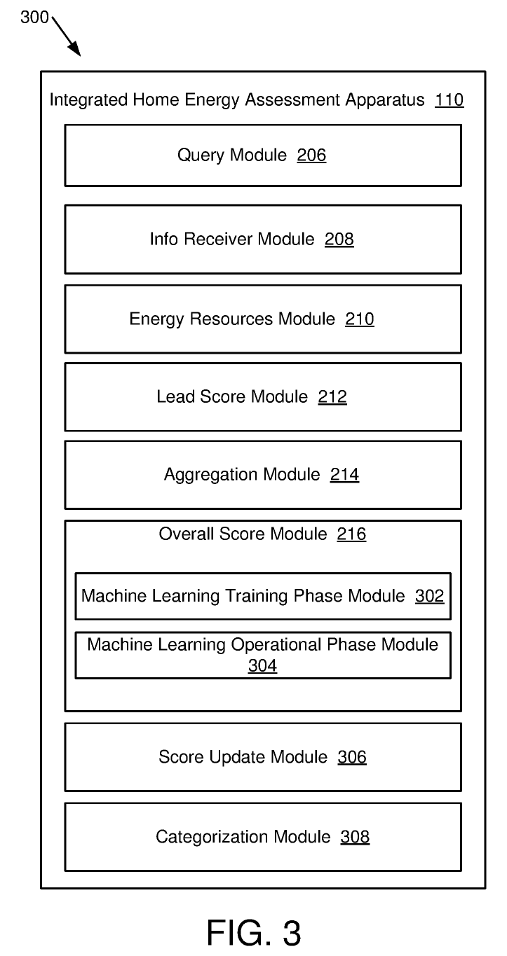

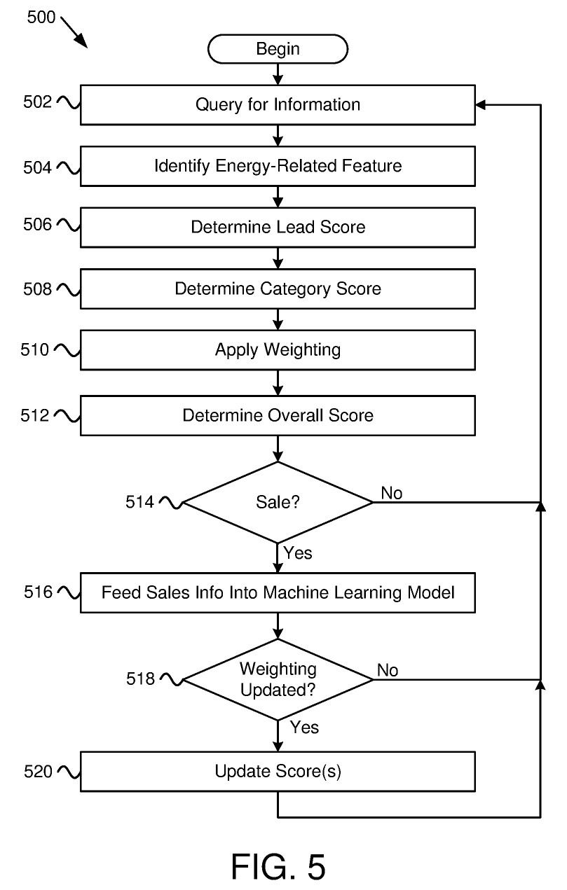

The apparatus 200 includes an overall score module 216 configured to determine an overall score for the home based on the category score for each of the scoring categories. In some embodiments, the overall score module 216 aggregates the category scores for each of the scoring categories to determine the overall score. In some embodiments, the overall score module 216 sums the score from each of the scoring categories. In other embodiments, as discussed in more detail with reference to FIGS. 3 and 5 below, the overall score module 216 is configured to apply a predetermined weighting to each category score prior to aggregating the category scores.

FIG. 3 is a schematic block diagram illustrating another apparatus 300 for assessing a sales lead for a home energy product, according to various embodiments. The apparatus 300 includes another integrated home energy assessment apparatus 110 with a query module 206, an information receiver module 208, an energy resources module 210, a lead score module 212, and an aggregation module 214, which are substantially similar to those described above in relation to the apparatus 200 of FIG. 2. In various embodiments, the apparatus 300 further includes an overall score module 216 with a machine learning training phase module 302 and a machine learning operational phase module 304, a score update module 306, and/or a categorization module 308, which are described below. In some embodiments, the apparatus 300 of FIG. 3 is implemented similar to the apparatus 200 of FIG. 2.

In some embodiments, the overall score module 216 includes machine learning algorithms that refine the energy-related feature identification and lead scoring processes substantially continuously such that the integrated home energy assessment apparatus 110 learns from historical data and updated data.

As used herein, machine learning refers to a device’s or system’s ability to automatically learn and improve from experience without being explicitly programmed. The machine learning training phase module 302 and the machine learning operational phase module 304 utilize machine learning. Machine learning focuses on the development of computer programs that can access data and use it to learn for themselves. Various machine learning algorithms are contemplated and may be employed herein, including supervised or unsupervised learning algorithms, neural networks, and/or other deep learning algorithms.

In some embodiments, the overall score module 216 includes a machine learning training phase module 302 and a machine learning operational phase module 304. During the initial training phase, the machine learning training phase module 302 is configured to train a machine learning model. The machine learning model has various electronic database inputs including, for example, demographic data, aerial imaging data, property data, utility rate data, and/or the like. The machine learning training phase module 302 is configured to train the machine learning model to recognize energy-related features from the various inputs. The machine learning operational phase module 304 is configured to correlate the energy-related features identified by the machine learning model with actual information obtained from the home when a home energy product is sold, for example, or information is gathered while negotiating a sale. The actual information may include actual appliance data, actual utility rate data, actual property characteristics, and/or other actual data obtained directly from the homeowner and/or observation.

In some embodiments, the machine learning training phase module 302 is further configured to calibrate weighting factors implemented by the machine learning model for each of the energy-related features and/or scoring categories. This process involves analyzing historical data to identify the relative importance of the various energy-related features and scoring categories in predicting the outcomes of various home energy leads. In some embodiments, one or more of the weighting factors are dynamically adjusted based on specific campaign goals and/or market conditions. The machine learning operational phase module 304 is configured to update the weighting factors based on actual sales and non-sales of energy products. In this manner, the machine learning operational phase module 304 may determine an optimal mix of weighting factors used to identify the best sales leads.

To this end, in some embodiments, the machine learning training phase module 302 collects of a large dataset of previously assessed homes, including their energy-related features, scoring categories, and/or outcomes, such as whether the homeowner eventually purchased an energy product. This historical data may serve as the foundation for understanding how the energy-related features and scoring categories correlate with successful energy product sales and/or other desired outcomes.

The machine learning training phase module 302 may be configured to analyze the historical data to determine which features most significantly impact the overall energy efficiency and/or sales potential of a home. For example, factors such as the home's solar potential, insulation quality, or local utility rates might have varying levels of importance depending on the geographic location, market conditions, or specific energy products being considered. In some embodiments, the machine learning training phase module 302 assigns initial weighting factors to each energy-related feature and/or scoring category to reflect its relative importance in contributing to the overall lead score.

Once the initial learning model is trained, the machine learning operational phase module 304 may be configured to manage real-time data processing and ongoing calibration of weighting factors. In some embodiments, the machine learning operational phase module 304 thus ensures that the learning model remains accurate as new data becomes available and market conditions change. During the operational phase, the machine learning operational phase module 304 is configured to continuously process new data from various third-party databases 121 and/or user input. As new homes are assessed and new sales data is gathered, the machine learning operational phase module 304 may be configured to compare these outcomes with its predictions to measure accuracy. If the accuracy is below a predetermined threshold, the machine learning operational phase module 304 may be configured to automatically adjust the learning model to reflect the new information in a feedback loop. For example, if the data shows that homes with high solar potential are increasingly likely to result in solar product sales, the weighting for solar potential may be increased.

In this manner, the machine learning operational phase module 304 continuously refines the learning model over time, thereby enabling integrated home energy assessment apparatus 110 to adapt to changes in energy product offerings, regional differences, evolving consumer behaviors, and/or the like.

In some embodiments, the apparatus 300 includes a score update module 306 configured to work together with the machine learning operational phase module 304 to ensure that weightings are regularly recalibrated to keep the learning model accurate and relevant. In some embodiments, the machine learning operational phase module 304 updates the weightings in real time. The calibrated weightings directly influence the lead scores, category scores, and overall scores generated by the integrated home energy assessment apparatus 110. Thus, the score update module 306 may be configured to dynamically update the lead scores for each of the energy-related features, the category scores, and/or the overall score in response to new data and/or changes in the weighting factors.

In some embodiments, the apparatus 300 includes a categorization module 308 configured to categorize homes into sales priority tiers based on their overall scores. In some embodiments, sales priority tiers include a numerical rating and/or any other suitable tier or designation. In one embodiment, for example, sales priority tiers are designated as Needs Nurturing, Bronze, Silver, Gold, and Platinum in ascending level of priority. In certain embodiments, each of the sales priority tiers may include one or more sub-tiers. In some embodiments, accurate and continuous calibration help to ensure that the integrated home energy assessment apparatus 110 is configured to accurately categorize homes and prioritize the most promising sales leads. In this manner, various embodiments may lead to more effective targeting by sales teams and better outcomes for homeowners due to homeowners being able to receive recommendations that are closely aligned with their energy needs and financial considerations.

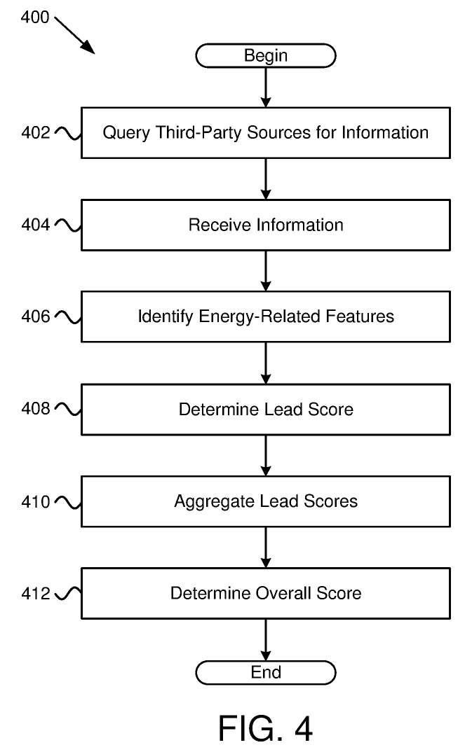

FIG. 4 is a flow diagram illustrating a method 400 for assessing a sales lead for a home energy product in accordance with some embodiments of the disclosure. The method 400 for assessing a sales lead for a home energy product includes querying 402 multiple third-party databases 121 for relevant home information. The information may include utility rate data 122, aerial imaging data 124, property data 126, demographic data 128, solar potential data 130, and/or any other relevant data. External or third-party databases 121 may include, for example, aerial imaging sources such as Google® Maps, Google® Earth, and/or Nearmap®; property data services such as Zillow® or CoreLogic®; demographic data sources such as the census bureau or ESRI® demographics; solar potential data sources such as NREL, HelioScope®, NOAA, or Dark Sky API; and/or any other suitable third-party data sources 121.

The method 400 includes receiving 404 the information from the third-party databases. In some embodiments, receiving 404 the information includes receiving at least a portion of the information from the homeowner and/or other authorized user. The method 400 includes identifying 406 multiple energy-related features of the home based on the information. These energy-related features may include the home’s insulation quality, the efficiency of its heating and cooling systems, its solar energy potential, and/or its historical energy consumption patterns. In some embodiments, each energy-related feature is mapped to at least one of several predefined scoring categories, such as solar system installation feasibility for the home, energy savings potential for the homeowner, financial readiness of the homeowner, and/or an engagement probability that the homeowner will engage with a solar system salesperson.

In some embodiments, the solar system installation feasibility scoring category may utilize roof characteristics of the home, local solar irradiance data, and/or local regulations and incentives to indicate the home’s solar potential. In some embodiments, the energy savings potential scoring category indicates a level of potential savings for the homeowner based on current energy consumption patterns, recommended efficiency improvements, and/or estimated solar production, for example.

In some embodiments, the financial readiness scoring category indicates a homeowner’s financial readiness to invest in energy efficient upgrades and solar products. The financial readiness scoring category may consider factors such as home equity, credit score, debt-to-income ratio, estimated savings to investment ratio, and/or the like.

In some embodiments, the engagement probability scoring category indicates a likelihood that the homeowner will engage with a salesperson with respect to energy efficient upgrades and/or solar products. The engagement probability scoring category may include factors such as homeowner demographics, homeowner interaction history with the platform, strength of referral partner relationships with homeowner, and/or stage in the home transaction process, if applicable.

The method 400 includes determining 408 a lead score for each of the energy-related features. In some embodiments, the lead score is a numerical value that reflects the potential impact of the energy-related feature on the overall energy assessment. In some examples, a home with a high solar potential might receive a high lead score in the solar feasibility category. In some embodiments, the method 400 includes aggregating 410 the lead scores within each of the scoring categories to generate a category score. The category score may provide a summary assessment of the home’s performance within that scoring category. In one embodiment, the energy savings potential category score implements a logarithmic scoring scale to account for diminished returns in energy savings over time.

The method 400 includes determining 412 an overall score for the home based on the category scores. In some embodiments, the overall score may simply be an aggregation of the category scores. In other embodiments, the overall score may be an average of the category scores, a weighted average of the category scores, and/or may include any other suitable calculation(s) based on the category scores.

FIG. 5 is a flow diagram illustrating another method 500 for assessing a sales lead for a home energy product in accordance with some embodiments of the disclosure. In some embodiments, the method 500 is for assessing a sales lead for a home energy product and incorporates some steps which are substantially similar to those described above in relation to the method 400 of FIG. 4. In some embodiments, the method 500 includes querying 502 multiple third-party databases for relevant home information and identifying 504 energy-related features from the information that is received. The method 500 includes determining 506 a lead score for each of the energy-related features. In some embodiments, the lead score is a numerical value or other desired value or designation that reflects the potential impact of the energy-related feature on the overall energy assessment. Each energy-related feature may be mapped to one of multiple predefined scoring categories. In some embodiments, the scoring categories include solar system installation feasibility for the home, energy savings potential for the homeowner, financial readiness of the homeowner, and/or an engagement probability that the homeowner will engage with a solar system salesperson.

The method 500 includes determining 508 a category score for each of the predefined scoring categories based on the lead scores of the energy-related features within that scoring category. In some embodiments, individual lead scores within each scoring category are simply aggregated, summed, and/or averaged to generate a category score. In other embodiments, a linear weighting approach may be implemented such that each lead score within a scoring category is multiplied by a corresponding predetermined weight and the weighted lead scores are then summed to calculate the category score.

In some embodiments, the category score is an average of the sum of the weighted lead scores within the scoring category. In some embodiments, a lead score may be multiplied by the weighting factor and then added to one or more weighting factors prior to summing the lead scores. Application of weighting factors to lead scores in this manner allows the method 500 to reflect varying priorities, market conditions, customer needs, and/or other impactful circumstances or events.

For example, in some embodiments, if a home’s solar potential has a lead score of 80 and the weight assigned to solar potential is 0.3, the contribution of solar potential to the category score would be 80 * 0.3 = 24. The same process may be repeated for other features, and their weighted contributions may be summed to produce the final category score.

The method 500 further includes applying 510 a weighting or weighting factor to each category score to determine 512 an overall score. In some embodiments, the weightings are determined during the training phase of a machine learning model and reflect the relative importance of each scoring category, as discussed above with reference to the apparatus 300 of FIG. 3.

In some embodiments, a hierarchical weighting system may be implemented to apply different levels of weightings to reflect the relative importance of different energy-related features and/or scoring categories. For example, within the energy savings potential scoring category, the method 500 may assign a higher weight to insulation quality compared to window efficiency, thereby reflecting that insulation has a greater relative impact on energy savings. Additionally, the entire energy savings scoring category might be given a higher weight compared to financial readiness in calculating the overall score, based on market demands.

In some embodiments, the method 500 adjusts the weights dynamically in response to changes in market conditions, regional factors, or evolving consumer preferences. The method 500 may use real-time data to update weightings, ensuring that the lead scores and category scores remain relevant. For example, in a region where utility rates have recently increased, the method 500 may dynamically increase the weight assigned to the energy savings potential scoring category, as homeowners in that region may now prioritize cost savings from energy efficiency improvements. In some embodiments, the weighting factors are determined and/or adjusted to reflect individual user preferences or priorities.

To determine 512 the overall score for the home, each weighting factor may be applied 510 to a corresponding category score and the resulting category scores may be aggregated and/or averaged. In weighted averaging, each category score is multiplied by its weight, and the results are averaged to produce the overall score. This approach smooths out the impact of extreme values and helps to ensure a balanced overall score. In some embodiments, weighting factors are adjusted based on geographic data, such as regional energy policies, climate, or utility rates. This helps to ensure that the overall score is tailored to the specific energy landscape of different areas.

The method 500 determines 514 whether there was a resulting sale. If the method 500 determines that there was not a sale, the method 500 returns and queries 502 for information for a next home. If the method 500 determines 514 that there was a sale, in some embodiments, a sales event triggers further actions within the method 500 to refine the learning model, such as the method 500 may feed 516 the sales information into the machine learning model. The sales information may include, for example, details about the energy product purchased, the homeowner’s decision-making process, and/or any other relevant follow-up information. This feedback loop may enable the machine learning model to learn from real-world outcomes to improve its predictive accuracy over time.

In some embodiments, the method 500518 whether the weighting factors have been updated. If the method 500 determines 518 that the weighting factors have been updated, the method 500 updates 520 the lead scores, category scores, and/or overall score based on the new weightings and the method 500 returns and queries 502 for information about a home. If the method 500 determines 518 that the weighting factors have not been updated, the method 518 returns and queries 502 for information about a home. This decision point 518, in some embodiments, facilitates accuracy of the overall score since the overall score is highly dependent on the relevance of the weightings.

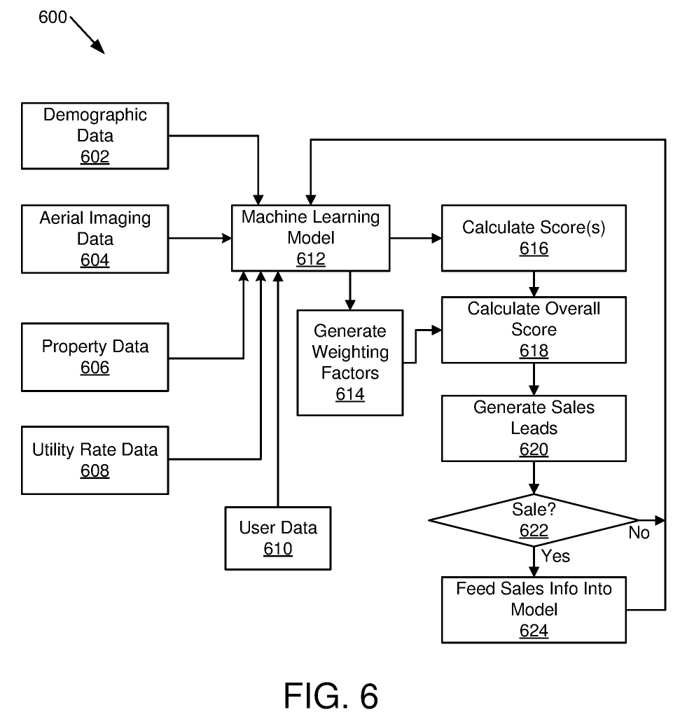

FIG. 6 is a schematic block/flowchart diagram illustrating a system 600 using machine learning to assess a sales lead for a home energy product, according to various embodiments. As shown, the system 600 comprehensively integrates multiple sources of data 602, 604, 606, 608, a machine learning model 612 configured to generate weighting factors, and a feedback loop that continuously improves the accuracy and effectiveness of the system 600.

In some embodiments, the system 600 collects information from a wide range of third-party databases 602, 604, 606, 608 to build a profile of a home’s energy characteristics. In some embodiments, one or more third-party databases 602, 604, 606, 608 provide to the system 600 demographic data 602 regarding the homeowner’s demographics such as income levels, household size, and age. In some embodiments, one or more third-party databases provide aerial imaging data 604 including imagery of the home and its surroundings that may be used to assess solar potential, shading, roof condition, and other external factors that may influence energy efficiency. In some embodiments, one or more third-party databases provide property data 606 that includes detailed information about the home’s physical characteristics such as square footage, building materials, age, and insulation levels. In some embodiments, one or more third-party databases provide utility rate data 608 that includes information about local utility rates.

In certain embodiments, the system 600 collects user data 610 provided directly by the homeowner and/or other authorized user. User data 610 may include, for example, information about current energy usage, preferences for energy products, and any previous energy assessments or upgrades. In some embodiments, user data 610 allows for a more personalized assessment, reflecting the homeowner’s specific circumstances and needs.

In some embodiments, various data inputs 602, 604, 606, 608, 610 are fed into the machine learning model 612 for integration and processing. In some embodiments, the machine learning model 612 analyzes the combined data 602, 604, 606, 608, 610 to identify key energy-related features of the home, such as its solar potential, insulation quality, and energy consumption patterns. Each energy-related feature may include an associated lead score and may correspond to one of multiple scoring categories. In certain embodiments, the machine learning model 612 utilizes historical data, including sales outcomes and performance metrics, to generate 614 weighting factors for various lead scores and/or scoring categories. These weighting factors may reflect the relative importance of different energy-related features in calculating the overall score.

In some embodiments, an overall score 618 for the home may be calculated based on a weighted average or aggregation of the category scores that applies or otherwise takes into account the weighting factors 614. In this manner, the overall score 618 may reflect a balanced consideration of all relevant factors, weighted according to their importance. In some embodiments, the overall score may be used to generate 620, categorize, and/or prioritize sales leads.

In some embodiments, the system 600 includes a feedback loop such that the machine learning model 612 is configured to learn from real-world outcomes. In this manner, the system 600 refines its predictions and weighting factors over time. To this end, in certain embodiments, the system 600 queries 622 whether a sale was successfully made. If not, no adjustments are made to the machine learning model 612. If yes, details of the sales transaction, such as information about the product sold, the sales process, and/or any other relevant performance data are fed 624 back into the machine learning model 612 in a feedback loop. This ongoing refinement method facilitates responsiveness of the system 600 to market conditions, consumer behavior, and technological advancements, and other relevant factors.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An integrated home energy assessment apparatus to assess a sales lead for a home energy product, the apparatus comprising:
one or more processors; and
non-transitory computer readable storage media storing code, the code being executable by the one or more processors to perform operations comprising:
querying a plurality of third-party databases for information pertaining to a home;
receiving, from the plurality of third-party databases, the information;
analyzing, via machine learning, the information to identify a plurality of energy-related features of the home, wherein each of the plurality of energy related features corresponds to at least one of a plurality of scoring categories;
determining a lead score corresponding to each of the plurality of energy-related features within one of the plurality of scoring categories;
aggregating the lead scores within each of the plurality of scoring categories to generate a category score for each scoring category; and
determining an overall score for the home based on the category score for each of the plurality of scoring categories.

2. The integrated home energy assessment apparatus of claim 1, wherein the information comprises at least one of aerial imagery data, property data, utility rate data, and demographic data.

3. The integrated home energy assessment apparatus of claim 1, wherein receiving the information comprises receiving, from a homeowner via a user interface, at least a portion of the information.

4. The integrated home energy assessment apparatus of claim 1, wherein the plurality of energy-related features comprises at least one of property characteristics, energy consumption patterns, and solar energy potential.

5. The integrated home energy assessment apparatus of claim 1, wherein the plurality of scoring categories comprise at least one of a solar system installation feasibility for the home, an energy savings potential for a homeowner of the home, a financial readiness of the homeowner, and an engagement probability that the homeowner will engage with a solar system salesperson.

6. The integrated home energy assessment apparatus of claim 1, wherein determining the overall score comprises calculating a weighted average of the plurality of category scores.

7. The integrated home energy assessment apparatus of claim 6, wherein calculating the weighted average comprises assigning, in a training phase of the machine learning, a weighting to each of the plurality of category scores based on its relative importance.

8. The integrated home energy assessment apparatus of claim 7, wherein the operations further comprise updating, during an operational phase of the machine learning, the weighting.

9. The integrated home energy assessment apparatus of claim 8, wherein the operations further comprise dynamically updating at least one of the lead score, the category score, and the overall score in response to the updated weighting.

10. The integrated home energy assessment apparatus of claim 1, wherein the operations further comprise automatically categorizing the home into one of a plurality of tiers based on the overall score, wherein each of the plurality of tiers indicates a sales priority for the home.

11. A method for assessing a sales lead for a home energy product, the method comprising:
querying, by a processor, a plurality of third-party databases for information pertaining to a home;
receiving, by the processor and from the plurality of third-party databases, the information;
analyzing, via machine learning, the information to identify a plurality of energy-related features of the home, wherein each of the energy-related features corresponds to at least one of a plurality of scoring categories;
determining, by the processor, a lead score corresponding to each of the plurality of energy-related features within one of the plurality of scoring categories;
aggregating, by the processor, the lead scores within the one of the plurality of scoring categories to generate a category score; and
determining, by the processor, an overall score for the home based on the category score for each of the plurality of scoring categories.

12. The method of claim 11, wherein receiving the information further comprises receiving, from a homeowner via a user interface, at least a portion of the information.

13. The method of claim 11, wherein determining the overall score comprises calculating a weighted average of the plurality of category scores.

14. The method of claim 13, wherein calculating the weighted average comprises assigning, in a training phase of the machine learning, a weighting to each of the plurality of category scores based on its relative importance.

15. The method of claim 14, further comprising updating, during an operational phase of the machine learning, the weighting.

16. The method of claim 15, further comprising dynamically updating, by the processor, at least one of the lead score, the category score, and the overall score in response to the updated weighting.

17. A computer program product comprising a computer readable storage medium and program code, the program code being configured to be executable by a processor to perform operations comprising:
querying a plurality of third-party databases for information pertaining to a home;
receiving, from the plurality of third-party databases, the information;
analyzing, via machine learning, the information to identify a plurality of energy-related features of the home, wherein each of the plurality of energy-related features corresponds to at least one of a plurality of scoring categories;
determining a lead score corresponding to each of the plurality of energy-related features within one of the plurality of scoring categories;
aggregating the lead scores within each of the plurality of scoring categories to generate a category score for each scoring category; and
determining an overall score for the home based on the category score for each of the plurality of scoring categories.

18. The computer program product of claim 17, wherein determining the overall score comprises calculating a weighted average of the plurality of category scores.

19. The computer program product of claim 18, wherein calculating the weighted average comprises assigning, in a training phase of the machine learning, a weighting to each of the plurality of category scores based on its relative importance.

20. The computer program product of claim 19, wherein the operations further comprise updating, during an operational phase of the machine learning, the weighting.
